(19) United States
(12) Patent Application Publication
(10) Pub. No.: US 2004/0266489 A1
(43) Pub. Date: Dec. 30, 2004

(54) Remote control of a mobile telephone, having a plurality of different operating characteristics

(75) Inventors: Jan Chipchase, Tokyo (JP); Per Persson, Helsinki (FI); Petri Piippo, Karkkila (FI); Tetsuya Yamamoto, Chiba (JP); Mikko Aarras, Helsinki (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/607,671

(22) Filed: Jun. 27, 2003

(51) Int. Cl. H04B 1/38

(52) U.S. Cl. 455/567; 455/418; 455/575.2; 455/415

(57) ABSTRACT

A mobile telephone, having a plurality of different operating characteristics, the mobile telephone comprising:

a wireless receiver for receiving a control message from a remote controller; and

a processor for controlling at least one operating characteristic of the mobile telephone in response to the received control message.

### FIELD OF THE INVENTION

Embodiments of the present invention relate to the remote control of a mobile telephone, having a plurality of different operating characteristics.

### BACKGROUND TO THE INVENTION

At present the operation of a mobile cellular telephone may be selectively controlled by a user. For example, a user may select one of several different profiles. A profile is a set of one or more operational characteristics of the mobile cellular telephone. These operational characteristics may determine how the mobile telephone responds to an incoming call or an incoming text message and/or the characteristics of the alerts made by the mobile telephone. For example, each profile may separately define one or more of the following: whether the incoming call alert is active or inactive, the volume of the audio incoming call alert, the identity of the ring-tone used by the audio incoming call alert, whether a vibrator alert is active or inactive, the type of audio alert made when a key of the input device is actuated and the volume of an alarm clock alert or a reminder alert.

The user can typically select one of multiple profiles offered by the mobile telephone as an operative profile. Thus by a single selection, multiple operating characteristics of the telephone may be altered.

A disadvantage of prior art telephones is that a user may forget to change the operative profile of the mobile telephone, after the circumstances necessitating that profile have passed. For example, a user may mute the telephone by selecting a Silent profile when entering a theatre or a meeting and forget to change the profile when the user leaves the meeting or theatre.

### BRIEF SUMMARY OF THE INVENTION

According to one aspect of the present invention there is provided a mobile telephone, having a plurality of different operating characteristics, the mobile telephone comprising: a wireless receiver for receiving a control message from a remote controller; and a processor for controlling at least one operating characteristic of the mobile telephone in response to the received control message.

According to another aspect of the present invention there is provided a remote controller for use with a mobile telephone, comprising: a user input device; and a wireless transmitter for transmitting a control message for controlling at least one operating characteristic of the mobile telephone in response to user activation of the user input device.

Thus a user can easily change the operating characteristics of a mobile telephone remotely.

According to a further aspect of the present invention there is provided a mobile telephone arrangement comprising: a mobile telephone, having a plurality of different operating characteristics, and a remote controller, wherein the mobile telephone comprises: a wireless receiver for receiving a control message from a remote controller; and a processor for toggling between at least a first operating characteristic of the mobile telephone and a second operating characteristics of the mobile telephone in response to the received control messages from a remote controller; and wherein the remote controller, comprises: a user input device; and a wireless transmitter for transmitting a control message in response to user activation of the user input device.

The remote controller may additionally comprise an indicator for indicating the status of the toggle. Thus a user can be conveniently reminded when it may be appropriate to toggle the operating characteristics of the mobile telephone.

The above defined wireless transmitter of the remote controller may be provided by a first wireless transceiver. The above described wireless receiver of the mobile telephone may be provided by a second wireless transceiver.

### BRIEF DESCRIPTION OF THE DRAWINGS

An embodiment of the invention will now be described by way of example only, with reference to the accompanying drawings, in which:

FIG. 1 is a schematic diagram of a remote controller and a mobile telephone;

FIG. 2 is a view from one side of a remote controller;

FIG. 3 is a view from the other side of the remote controller shown in FIG. 2; and

FIGS. 4A and 4B show a profiles screen of a mobile telephone in which different profiles are respectively selected.

### DETAILED DESCRIPTION OF EMBODIMENT(S) OF THE INVENTION.

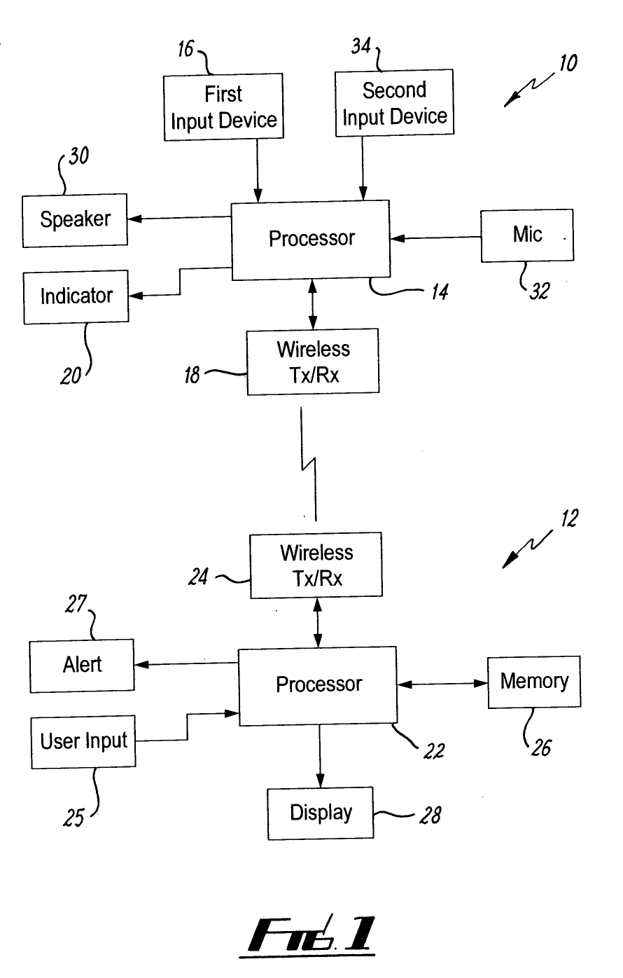

FIG. 1 is a schematic drawing of a remote controller 10 and of a relevant part to a mobile cellular telephone 12.

The mobile cellular telephone 12 comprises a processor 22, a memory 26, a wireless transceiver 24, a display 28, a user input device 25 and an alert 27.

The processor 22 controls the operation of the mobile cellular telephone 12. It is connected to read to and write from memory 26, so that it controls the display 28, so that it controls the operation of the alert 27, so that to can receive messages via the wireless transceiver 24 and so that it can receive input signals from the user input device 25. The alert 27 includes an audible alert and may include a vibration alert.

The operation of the mobile cellular telephone 12 may be selectively controlled by a user. For example, a user may select one of several different profiles. A profile is a set of one or more operational characteristics of the mobile cellular telephone 12. These operational characteristics may determine how the mobile telephone 12 responds to an incoming call or an incoming text message and/or the characteristics of the alerts made by the mobile telephone. For example, each profile may separately define one or more of the following: whether the incoming call alert is active or inactive, the volume of the audio incoming call alert, the identity of the ring-tone used by the audio incoming call alert, whether a vibrator alert is active or inactive, the type of audio alert made when a key of the user input device 25 is actuated and the volume of an alarm clock alert or a reminder alert.

An indication of the currently operative profile is generally displayed on display 28 . The absence of such an indication, itself indicates that the default profile of the telephone is operative.

The profiles may be pre-programmed within the memory 26. Alternatively, or in addition, the user can program one or more profiles using the user input device 25. The user specifies the operational characteristics associated with a profile, for example, programming how the telephone responds to an incoming call or text message.

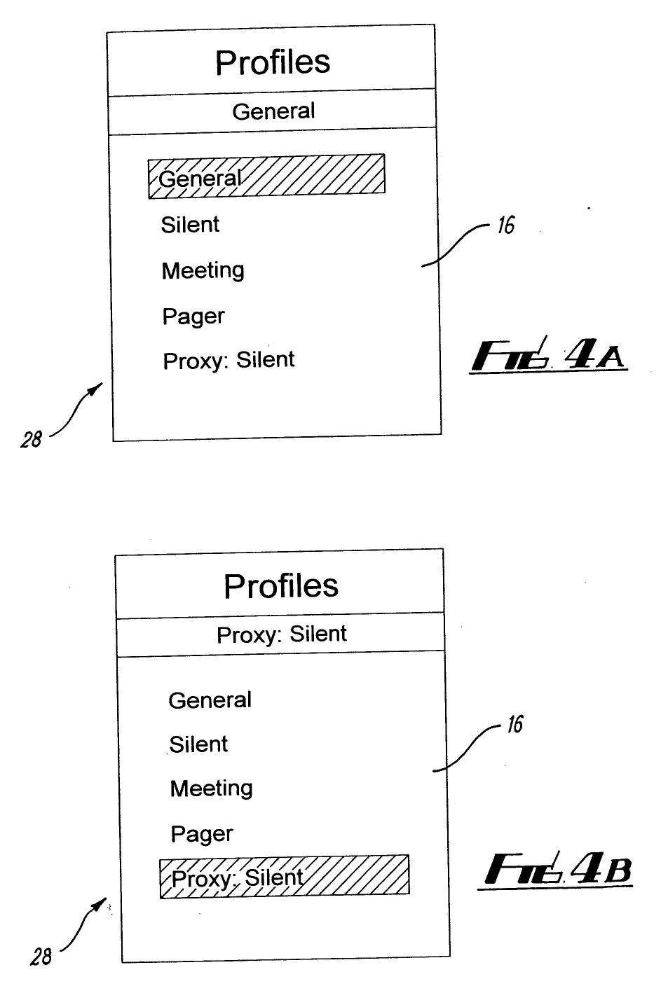

In the embodiment shown in FIGS. 4A and 4B there are five different operating characteristics, which have been called for convenience “General”, “Silent”, “Meeting”, “Pager” and “Proxy: Silent”. The first four, namely “General”, “Silent”, “Meeting” and “Pager” are selectable when using the mobile telephone 12 itself. The fifth profile, namely “Proxy: Silent” relates to a profile that can be selectively toggled on/off using the remote controller 10. The operating characteristics of the “Proxy: Silent” profile are preferably pre-programmed so that the telephone is muted and the vibration alert, if any, is deactivated.

The remote controller 10, in this example, comprises a processor 14, a first input device 16 for providing an input to the processor 14, a second input device 34 for providing an input to the controller 14, a microphone 32, indicator 20, a speaker 30 and a wireless transceiver 18, all of which are separately connected to the processor 14.

The remote controller 10 may be used by a user to remotely select an operative profile for the mobile cellular telephone 10.

When a user actuates the first input device 16, for example by pressing a button, the processor 14 controls the wireless transceiver 18 of the remote controller 10 to send a first message, which is for reception by the wireless transceiver 24 of the mobile cellular telephone 12. The processor 14 also activates the indicator 20, which may be a light. The wireless transceivers 18, 24 may use any suitable communication protocol. They may communicate using modulated infra-red radiation, but preferably communicate using a low power radio frequency protocol e.g. Bluetooth (trademark).

When the wireless transceiver 24 of the mobile cellular telephone 12 receives the first message, it informs the processor 12. The processor 12 responds to this message by storing a record of the currently operative profile in memory 26 and changing the operative profile of the mobile cellular telephone 12 to the Proxy profile. The processor 12 reads the operating characteristics of the Proxy profile from the memory 26 and applies them. Thus the telephone is muted and the display indicates that the Proxy profile is operative.

When the user again actuates the first input device 16, the profile setting of the mobile cellular telephone is returned to the profile setting operative before the Proxy setting was selected. The processor 14 controls the wireless transceiver 18 of the remote controller 10 to send a first message, which is for reception by the wireless transceiver 24 of the mobile cellular telephone 12. The processor also de-activates the indicator 20, which may be a light.

When the wireless transceiver 24 of the mobile cellular telephone 12 receives the first message, it informs the processor 12. The processor 12 responds to this message by reading the record of the previous profile from the memory 26 and changing the operative profile of the mobile cellular telephone 12 to that profile. The processor 12 reads the operating characteristics of the newly operative profile from the memory 26 and applies them.

The processor 12 is operable to change the profile setting even while it produces an alert. Thus the remote controller may be used to silence an alert, by instantaneously changing the profile setting.

Thus the first input device 16 of the remote controller 10 can be used to toggle the operative profile of the mobile telephone 12 between first and second profiles. The status of the toggle is indicated using indicator 20. This provides a useful visual reminder to a user of the profile status of the mobile telephone and reduces the likelihood that a user will inadvertently keep the telephone in the Proxy profile even after the surrounding circumstances requiring this profile, such as a meeting, have passed.

Although only toggling of the Proxy profile has been described, it would be a simple matter to allow a user to select one of many different profiles using the remote controller 10. It may in this case be desirable to replace the indicator light 20 with a indicator display (not shown) that can display an indication of the selected profile. The profiles available for selection using the remote controller may be the same or different to those available for selection from the telephone itself.

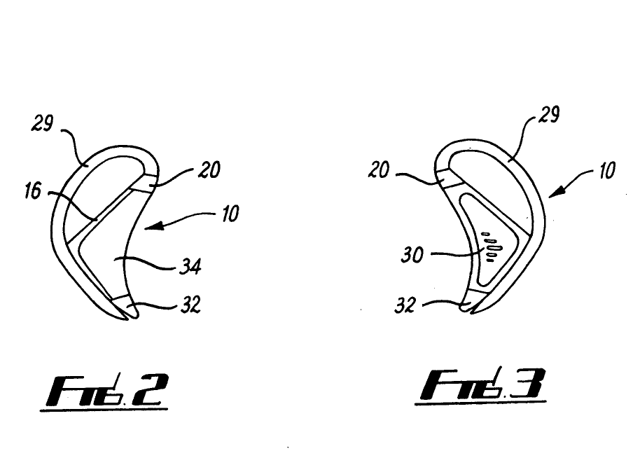

FIGS. 2 and 3 show a specific embodiment of the remote controller 10, which as can be seen includes a clip 29 to enable the user to attach the remote controller 10 to his ear, or to a lapel or a pocket.

The remote controller 10 may additionally be used as a ‘hands free’ input/output device. This, for example, allows a user, while remote from the telephone, to carry out a telephone conversation using the mobile cellular telephone or issue voice commands to the mobile telephone. When the remote controller 10 is attached to a user's ear, preferably the right ear, the user receives audio output via the speaker 30 and can provide audio input via the microphone 32.

The remote controller 10 may be toggled on/off, by activating the second user input device 34 for a period of time longer than one second. When the remote controller 10 is switched on, it sends a second message to the mobile telephone 12 using the wireless transceiver 18. The processor 22 of the mobile telephone 12 responds to the received second message to add the Proxy profile to the list of profile settings for selection as shown in FIG. 4A. When the remote controller 10 is switched off it sends a second message to the mobile telephone 12 using the wireless transceiver 18. The processor 22 of the mobile telephone 12 responds to the received second message to remove the Proxy profile from the list of profile settings for selection.

The telephone 12 receives incoming calls via a cellular radio transceiver (not shown). The processor 22, in response to an incoming call, may send a third message from its wireless transceiver 24 to the wireless transceiver 18 of the remote controller 10. The processor 14 of the remote controller 10 responds to a received third message by intermittently activating the indicator 20. This alerts the user to the incoming call.

A user accepts a call using the remote controller 10 by activating the second user input device 34 for a period of time of less than one second. This sends a signal to the processor 14, which causes the wireless transceiver 18 to transmit a fourth message to the wireless transceiver 24 of the mobile telephone 12. The processor 22 responds to the received fourth message by answering the incoming call. The telephone 12 then activates the speaker and microphone 32 of the remote controller and the telephone conversation is carried out over a duplex link between the wireless transceiver 18 of the remote controller 10 and the wireless transceiver 24 of the mobile cellular telephone 12.

A user ends the call, by activating the second user input device for a period of time of less then one second and the appropriate signals are then sent to cause the mobile telephone 12 to end the call.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A mobile telephone, having a plurality of different operating characteristics, the mobile telephone comprising:
a wireless receiver for receiving a control message from a remote controller; and
a processor for controlling at least one operating characteristic of the mobile telephone in response to the received control message.

2. A mobile telephone as claimed in claim 1, wherein the at least one operating characteristic is an alert characteristic that determines how the mobile telephone alerts a user.

3. A mobile telephone as claimed in claim 1, wherein the at least one operating characteristic is an alert characteristic that determines how the mobile telephone alerts a user to an incoming call.

4. A mobile telephone as claimed in claim 3, wherein the at least one characteristic mutes the mobile telephone.

5. A mobile telephone as claimed in claim 1, wherein the processor is operable to use a first one of a plurality of predetermined sets of operating characteristics in the mobile telephone in response to the received control message.

6. A mobile telephone as claimed in claim 5, wherein the first set of operating characteristics are selectable only in response to a received control message.

7. A mobile telephone as claimed in claim 5, wherein the processor is operable to add an identifier of the first set of operating characteristics to a displayable list of identifiers identifying the plurality of sets of operating characteristics.

8. A mobile telephone as claimed in claim 1, wherein the processor is operable to toggle between at least a first operating characteristic of the mobile telephone and a second operating characteristics of the mobile telephone in response to the received control messages from the remote controller.

9. A remote controller for use with a mobile telephone as claimed in claim 1, comprising:
a user input device; and
a wireless transmitter for transmitting a control message, for controlling the at least one operating characteristic of the mobile telephone, in response to user activation of the user input device

10. A remote controller as claimed in claim 9, further comprising an indicator for indicating the status of the at least one operating characteristic of the mobile telephone.

11. A remote controller as claimed in claim 9, wherein a control message is transmitted in response to a single activation of the user input device.

12. A remote controller as claimed in claim 9, further comprising a second user input device for switching the remote controller on and off and for answering and ending an incoming call to the mobile telephone.

13. A remote controller according to claim 9 incorporating a clip, by means of which the controller can be clipped to an ear of a user and to an item of the user's clothing.

14. A remote controller for use with a mobile telephone as claimed in claim 4, comprising:
a user input device;
a wireless transmitter for transmitting a control message for muting the mobile telephone in response to user activation of the user input device; and
an indicator for indicating when the mobile telephone is muted.

15. A remote controller for use with a mobile telephone, comprising:
a user input device; and
a wireless transmitter for transmitting a control message for controlling at least one operating characteristic of the mobile telephone in response to user activation of the user input device

16. A mobile telephone arrangement comprising:
a mobile telephone, having a plurality of different operating characteristics, and a remote controller, wherein the mobile telephone comprises:
a wireless receiver for receiving a control message from a remote controller; and
a processor for toggling between at least a first operating characteristic of the mobile telephone and a second operating characteristics of the mobile telephone in response to the received control messages from a remote controller; and wherein
the remote controller, comprises:
a user input device; and
a wireless transmitter for transmitting a control message in response to each user activation of the user input device.
